(19) United States
(12) Patent Application Publication
(10) Pub. No.: US 2005/0145044 A1
(43) Pub. Date: Jul. 7, 2005

(54) Six degrees of freedom mirrored cantilever extensometer

(76) Inventor: Wilbur Leslie Dublin JR., Georgetown, TX (US)

Correspondence Address: Tim Cook;Law Office of Tim Cook P.C., P.O. Box 10107, Liberty, TX, 77575, US

(21) Appl. No.: 10/752,182

(22) Filed: Jan. 6, 2004

(51) Int. Cl. G01L 1/00

(52) U.S. Cl. 73/862.639; 73/760

(57) ABSTRACT

An extensometer measures and monitors changes in complex loads on a structure. The extensometer comprises opposed cantilever beams fixed in “mirrored” position and aligned with the structure. Each beam has a fixed end and a free end. The fixed end of the cantilever beam is attached to the structure being monitored. The free ends are attached to each other through a compliant, linearly elastic sensing element that is distorted by rigid-body motions of the cantilever beams relative to their attachments to the structure. The sensing element is capable of first order isolation of signals from discrete components of deflections of the structure in proportional response to the strains or stresses on the structure.

### FIELD OF THE INVENTION

This invention is directed to an extensometer to measure displacements resulting from forces exerted upon a structure, and more particularly to an extensometer comprising opposed cantilever beams fixed in “mirrored” position with respect to each other, and preferably aligned with the stress/strain axis of interest on the structure (usually the principal axis). This structure and alignment isolates and magnifies discrete linear and angular triaxial displacements that are induced by complex loads acting on the structure. Equivalent strains, stresses, and loads can be calibrated, or calculated from the displacement outputs of the extensometer.

### BACKGROUND OF THE INVENTION

All physical structures experience complex loads of varying degree. The loads can be relatively constant in magnitude, or change in magnitude with time. Changes can occur over a relatively long period of time from factors such as aging or wear, or can occur over a relatively short period of time from factors such as impact, wind, water pressure, and the like. Loads have discrete orientation with the structure and cause linear and rotational triaxial displacements and thereby exhibit as many as six components of displacement (three linear, and three angular or rotational) or “degrees of freedom”.

Virtually all structures should be inspected on a regular schedule for adverse effects of complex loads. As an example, bridges are weakened over time by many factors such as usage and the effects of the elements. Bridges are also weakened, or at least exposed to threatening loads, by short term events such as collisions, fire, wind, water surges, and the like. Routine inspections may detect long term damage prior to catastrophic failure, although such inspections are labor intensive, typically qualitative in nature, expensive, and often are not performed on schedule. Routine inspections are virtually useless in providing warnings of catastrophic failure due to short term events.

Other structures including towers, buildings, aircraft, ship hulls, and electrical or fiber optic transmission lines are threatened by adverse effects of long term loads such as those cited above. These structures are likewise subject to catastrophic failure due to short term events. Routine inspections are relatively inefficient in warning of impending structural failure due to long term events, and essentially useless in warning of structural failure due to short term events.

In view of these factors, a system is needed to monitor complex loads on a structure in real time so that indications of structural flaws can be detected and remedial measures can be taken before structural failure. The system should preferably be rugged, relatively inexpensive, easily mounted, and as sensitive as possible in isolating and magnifying discrete linear and angular triaxial displacements induced by complex loads acting on the structure. The system should display load data as a function of time so that the data can be monitored and continuously analyzed by skilled personnel.

### SUMMARY OF THE INVENTION

A mirrored, cantilever extensometer of the present invention measures and monitors changes in complex loads acting on a structure. The extensometer comprises opposed cantilever beams fixed in “mirrored” position with respect to each other, and fixed in alignment with the structure, thereby isolating and magnifying discrete linear and angular triaxial displacements that are induced by complex loads acting on the structure. Each cantilever beam comprises a first and a second end, which will hereafter be referred to as a “fixed” end and a “free” end. The fixed ends of the cantilever beams are operationally attached to the structure being monitored. The free ends of the cantilever beams are attached to each other through a compliant, linearly elastic sensing element that is distorted by rigid-body motions of the cantilever beams relative to their attachments to the structure. The sensing element is capable of first order isolation of signals from discrete components of deflections of the structure in proportional response to the strains or stresses thereon. The resulting discrete components of load are measured, preferably in real time, by the extensometer that is attached to the structure at only two points. Each of the six components of displacement (or degrees of freedom) has its own strain gage bridge, on the sensing element, which produces a signal proportional to its component's displacement response to complex loading. Strains and stresses can be calculated from the displacements, or even acquired directly, if calibration of the component of the structure is calibrated with the extensometer attached thereto, and the calibration is accomplished with discrete values of force/strain/stress applied for each of the desired components.

The extensometer magnifies strains to yield high resolution measurements. Magnification is obtained through the ratio of cantilever beam length to sensing element length. Magnification is further increased by using bridges with up to four active arms on the sensing element. Magnification is still further increased by the design of the sensing element's geometry and stiffness.

Different types of sensing elements can be employed. One type of sensing element comprises a ring element with diametrically opposed integral lugs for attachment to the free ends of the cantilever beams. The ring elements are fabricated with flats upon which gage layouts are affixed. A second type of sensing element comprises a cruciform element of parallelepiped sections. Selected components of the apparatus of the cruciform element may preferably be tailored by using the design practice of constant strength beams. Evenly tapered “uniform strength” beams, the principles of which are well known in the art, can be used to provide constant bending stress from a beam that reacts to constant shear force that generates the bending stress for the component being sought. This results in constant curvature (i.e. a circular arc segment) to minimize the strain gradient acting on the strain gage to maximize the output for a given peak stress or strain. Use of taper necessary for uniform strength consideration can, however, cause difficulty in isolating other components of load. Other types of sensing elements can be employed.

The active components of the sensing element are disposed within a housing for protection from moisture, dirt, and other environmental factors. The housing is typically purged with dry, inert gas and is sealed with tapered rubber plugs or other sealing means and materials. The cover of the housing is mounted, and “floats” on low durometer O-rings to minimize second order force effects from housing to cantilevers.

The sensing element of the extensometer can be powered and controlled by an operationally attached electronics package thereby forming an extensometer system for monitoring complex loading of a structure. Signals from the sensing element are also detected, conditioned, and processed by elements within the electronics package. The electronics package outputs, in real time, measures of complex loads acting on virtually any type of structures including bridges, towers, buildings, aircraft, ship hulls, and electrical or fiber optic transmission lines. The system allows real-time diagnosis of structures, in dynamic as well as static conditions. The sensitivity of the monitoring system is scalable for virtually any practical range of service strain including post-yield conditions.

### BRIEF DESCRIPTION OF THE DRAWINGS

So that the manner in which the above recited features, advantages and objects the present invention are obtained and can be understood in detail, more particular description of the invention, briefly summarized above, may be had by reference to the embodiments thereof which are illustrated in the appended drawings.

FIG. 1 is a side view of the extensometer system that comprises an electronics package operationally connected to and an extensometer with a carrier bar in place;

FIG. 2 is a top view of the extensometer with the carrier bar;

FIG. 3 is an end view of the extensometer with the carrier bar removed;

FIG. 4 is a side view of a ring type sensing element;

FIG. 5 is a top view of a ring type sensing element;

FIG. 6 illustrates in detail the layout and function of individual bridge elements on the outer surface of the ring type sensing element;

FIG. 7 illustrates temperature sensors along with the layout and function of individual bridge elements on the cylindrical inner surface of the ring type sensing element; and

FIG. 8 illustrates elements of the electronics package of the extensometer system.

### DETAILED DESCRIPTION OF THE PREFERRED EMBODIMENTS

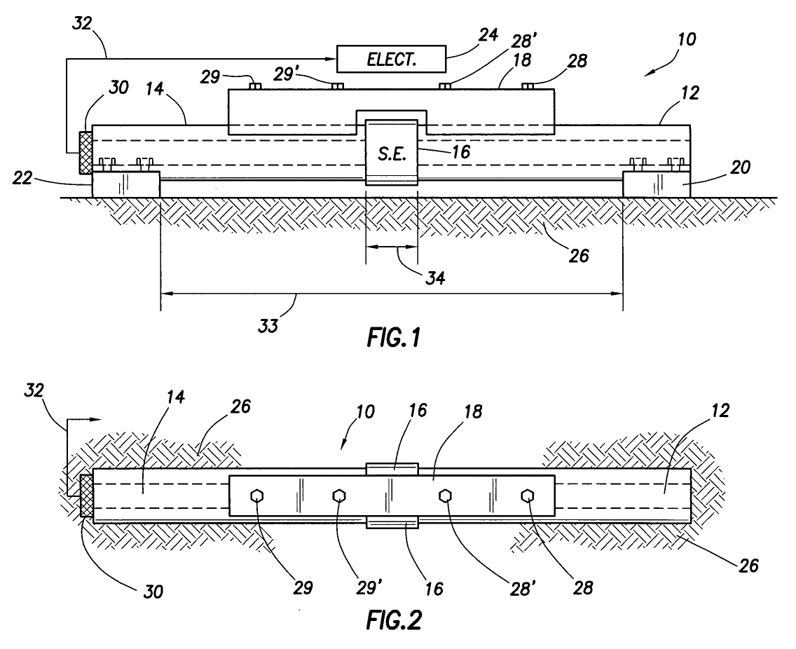

Attention is directed to FIG. 1, which is a side view of the extensometer system comprising an electronics package 24 and an extensometer 10. Major elements of the extensometer 10 are illustrated. The extensometer comprises opposed cantilever beams 12 and 14 fixed in a mirrored position with respect to a structure 26 thereby isolating and magnifying discrete linear and angular triaxial displacements that are induced by complex loads acting on the structure 26. Each cantilever beam 12 and 14 comprises a fixed end and a free end, wherein the fixed ends are rigidly attached to the structure 26. The free ends of the cantilever beams 12 and 14 are attached to each other through a compliant, linearly elastic sensing element 16 that is distorted by rigid-body motions of the cantilever beams 12 and 14 relative to their attachments to the structure 26.

Still referring to FIG. 1, the sensing element 16 is capable of first order isolation of signals from discrete components of deflections of the structure 26 in proportional response to the strains or stresses within the structure. The resulting discrete components of load are measured in real time by the extensometer 10. Each of the six components of displacement has its own strain gage bridge, on the sensing element 16, which produces a signal proportional to its component's strain or stress response to complex loading. The sensing element and related elements will be discussed in detail in a subsequent section of this disclosure.

Prior to installation on the structure 26, the extensometer is held in alignment near its unstrained state, which is established during initial assembly, by a carrier bar 18. The carrier bar 18 is removably attached to the cantilever beams by bolts. Preferably four bolts are used to increase rigidity of the stabilized assembly, with one bolt being near each end of a vee section 18′ of the carrier bar 18 (See FIG. 3). For purposes of clarity, only two bolts 28 and 29 are shown attaching the carrier bar 18 to the cantilever beams 12 and 14, respectively. The carrier bar 18 allows the extensometer 10 to be handled easily prior to installation, and is removed only after the extensometer has been installed on the structure 26. Should the extensometer 10 be removed from the structure 26, the carrier bar 18 must be reinstalled prior to removal of the extensometer assembly from the structure and handled independently. It is virtually impossible to handle the unstabilized extensometer 10 without destroying the sensing element 16.

Again referring to FIG. 1, the fixed ends of the cantilever beams 12 and 14 are operationally attached to the structure preferably by means of vee blocks 20 and 22, respectively. The vee blocks are preferably removably attached to their respective cantilever beams at the time of initial assembly of the extensometer 10. The base surface of each vee block 20 and 22 is preferably permanently attached to the structure 26 using a variety of techniques including welding, chemical bonding, studs (not shown) embedded in the structure 26, and even by magnetic bases if the attraction force is capable of distorting the sensing element 16 over the necessary range without slipping relative to the structure. Welding is preferred, if possible, since it can be done in a relatively short period of time, and with generally adequate strength from “tack” welding alone. It should be recalled that with the carrier bar 18 attached, the extensometer 10 assembly is very stiff relative to an unrestrained sensing element 16. In cases where deflections of the monitored structure 26 are continuous, such as a building or bridge exposed to high wind loads, chemical bonding agents will be “dithered” by dynamic displacements in the glue lines as well as offset by large static averages during curing to its effective rigidity. In some cases, dithering, during cure of adhesives, may seriously degrade the strength and stability of the chemical bonding between the vee blocks 20 and 22 and the structure 26.

Flat bottomed vee block bases are typical, although bases can be fabricated in virtually any contour to fit the structure 26 at the contact points. Once the vee blocks 20 and 22 are affixed to the structure 26, the carrier bar 18 can be removed by removing the bolts 28 and 29. The structure 26 is now coupled to the unrestrained sensing element 16 through the cantilever beams 12 and 14. The extensometer can be moved to another position on the structure 26, or to another structure. This is accomplished by reinstalling the carrier bar 18 to stabilize the assembly, and then removing vee block attachment bolts (not shown) that are accessible through ports which affix the cantilever beams 12 and 14 to the vee blocks 20 and 22, respectively. These ports are sealed with tapered “rubber” stoppers that are also sealed with a potting adhesive. New vee blocks are preferred when the extensometer is reinstalled. Prior to reinstallation, it is preferred that the extensometer 10 with newly attached vee blocks 20 and 22 be reset to original setting approximations before the carrier bolts are tightened.

Although not preferred, it should be understood that the fixed ends of the cantilever beams 12 and 14 can be affixed directly to the structure. This embodiment would require a shoulder or equivalent protrusion (not shown) on the underside of each cantilever beam at the point of contact. This elevates the free ends of the cantilever beams so that the affixed sensing element 16 can be distorted without contacting the structure 26. For purposes of this disclosure, the term “operationally attached” includes both the method of attaching the cantilever beams to the structure using vee blocks and the method of directly attaching the cantilever beams to the structure.

Once again referring to FIG. 1, different types of sensing elements 16 can be employed. One type comprises a ring element with diametrically opposed integral lugs for attachment to the free ends of the cantilever beams 12 and 14. This type will be discussed in detail in a subsequent section of this disclosure. An alternate type of sensing element 16 comprises a cruciform element of parallelepiped sections. Some of the components of the cruciform element are preferably tailored by using the design practice of constant strength beams. Evenly tapered cantilever beams provide constant bending stress from a constant shear force that generates the bending stress for the component being sought. This results in constant curvature (i.e. a circular arc segment) to minimize the strain gradient acting on the strain gage to maximize the output for a given peak stress or strain.

It should be understood that the sensing element 16 can alternately be of the type that responds to fewer than six degrees of freedom.

As illustrated conceptually in FIG. 1, the sensing element 16 is preferably powered by the electronics package 24 which is electrically connected to the sensing element by means of one or more conductors 32. The one or more conductors 32 traverse the hollow interior of the cantilever beam 14 and exit through a fitting 30. The electronics package 24 also comprises a display. Though shown as a separate component, it should be understood that the electronics package can be an integral part of the extensometer assembly 10. Features of the electronics package will be discussed in detail in a subsequent section of this disclosure. Active components of the sensing element 16 are disposed within a housing for protection from moisture, dust, and other environmental factors. The housing is typically purged with dry, inert gas such as nitrogen or argon. All openings in the housing, such as the fitting 30 through the one or more conductors 32 pass, are sealed preferably with tapered rubber plugs and/or other sealing materials such as urethane or silicone.

When installing the extensometer 10 in vertical positions, moisture inclusion into the interior of the sensing element 16 must be considered. It is recommended that the end with the fitting 30 be positioned upward to preclude long term moisture contact with this fitting. If the extensometer 10 is to be used in underwater applications, it is necessary to pressure compensate the housing of the sensing element 16 by filling it with oil and using a metal bellows equalizer and seal to balance the internal pressure of the housing to that at depth.

In some embodiments of the extensometer 10, the material of the sensing element 16 may differ from the material of the cantilever beams 12 and 14. As an example, the sensing element may be fabricated from an aluminum alloy and affixed as previously discussed to cantilever beams fabricated from steel. The difference of relative expansion between the aluminum alloy sensing element 16 and the steel cantilever structural combination is approximately 10 percent of the full scale output (FSO) per 100 degrees Fahrenheit for a 20 inch gage length 33 (see FIG. 1). Error decreases with decreasing gage length. This difference can adversely affect load measurements with rapidly changing temperature resulting from strong sun exposure, rain, hail, sleet, and the like. In situations where the extensometer 10 is exposed to rapid changes in temperature, temperature can be monitored and sensing element output can be corrected for these temperature variations using analytical means. The adverse effects of temperature are negligible for many installations.

The extensometer 10 is designed to magnify strains in order to yield high resolution measurements. Magnification is obtained through the ratio of gage length 33 to sensing element length 34, as defined in FIG. 1. As an example a gage length 33 of 20 inches (in) or 50.8 centimeters (cm) and a sensing element length of 2.0 in (5.1 cm) will yield a mechanical gain of 10. Magnification is further increased by using bridges with four active arms on the sensing element 16 to increase gain by an additional factor of up to 4 thereby yielding an extensometer system gain of 10×4=40. Magnification is still further increased from the design of the sensing element's geometry and stiffness, which can yield an extensometer system total gain of 100 or more. Additional gain can be obtained by using semiconductor strain gages, and by making radical changes in the geometry of the elements. A gain of about 100 is, however, adequate for most structural monitoring operations.

FIG. 2 is a top view of the extensometer 10 again showing the cantilever beams 12 and 14 affixed at their free ends to the sensing element 16. The carrier bar 18 is in place and attached to the cantilever beams 12 and 14 by the illustrated bolts 28 and 29, respectively. The one or more conductors 32, which operationally connect the electronics package 24 (see FIG. 1) to the sensing element 16, exit the hollow cantilever beam 14 through the fitting 30.

FIG. 3 is an end view of the extensometer 10 as seen from the left hand side of the side and top views shown in FIGS. 1 and 2, respectively. The fitting 30 has been omitted for clarity and to show the hollow center of the cantilever beam 14. The one or more conductors 32 are shown disposed within hollow the cantilever beam 14 and extending from the sensing element 16. Recalling that four bolts are actually used as previously discussed, the two illustrated bolts 28 and 29 are shown removed and the carrier bar 18 is separated from the cantilever beams 12 and 14 (see FIGS. 1 and 2) thereby leaving the sensing element 16 unconstrained and configured to monitor loads on the structure 26 via contacts through the vee blocks 22 and 20 (see FIG. 1). FIG. 3 clearly illustrates the vee grove in the top surface of the vee blocks that receive the round cantilever beams. A vee grove is also shown on the bottom surface of the carrier bar 18, which likewise receives the round cantilever beams when affixed thereto.

The cross section of the assembly 10 is not necessarily cylindrical. Lower profile can be obtained with rectangular or other geometry cross sections to minimize second order effects associated with the elevation of the center-line of the assembly above the surface 26 to which the extensometer is attached (the surface where the boundary conditions of the structural element resides). The cylindrical cross section of the cantilever 14 shown in FIG. 3 is the preferred embodiment for ease of manufacture installation and alignment; however, many cross sections may be used.

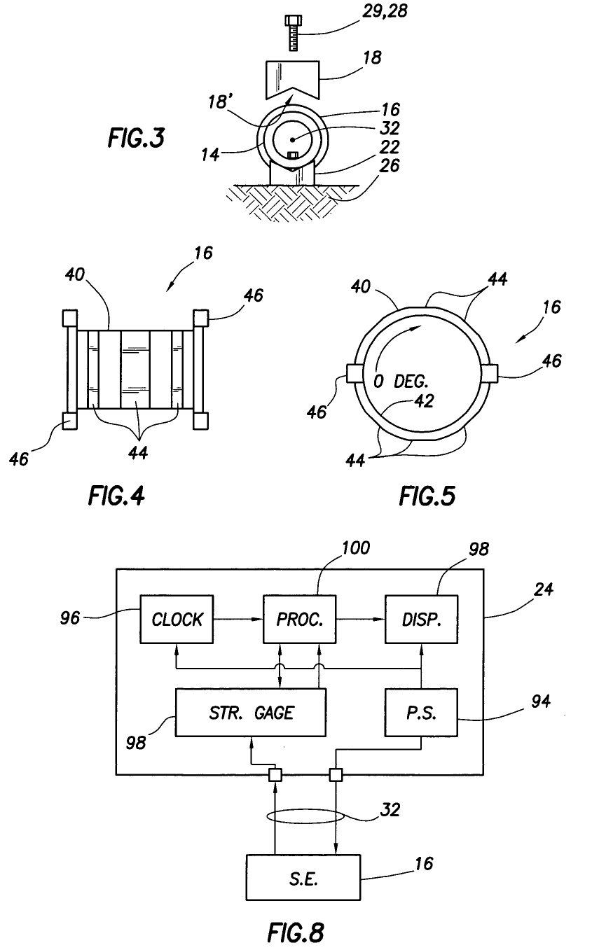

FIGS. 4 and 5 are side and top views, respectively, of a ring type sensing element 16. Diametrically opposed integral lugs 46 are used to attach the sensing element 16 to the free ends of the cantilever beams 12 and 14. Flats 44 are machined on the outer surface 40 of the ring-type sensing element 16, preferably on 45 degree centers. Azimuthal reference is shown in FIG. 5, with 0° facing left in FIGS. 1 and 2 and coincident with the major axis of the extensometer 10. FIG. 5 also defines a “reference plane” which is perpendicular to the major axis of the ring type sensing element 16 as shown in FIG. 4. This reference plane will be used in discussing sensing element bridge layouts in the following section.

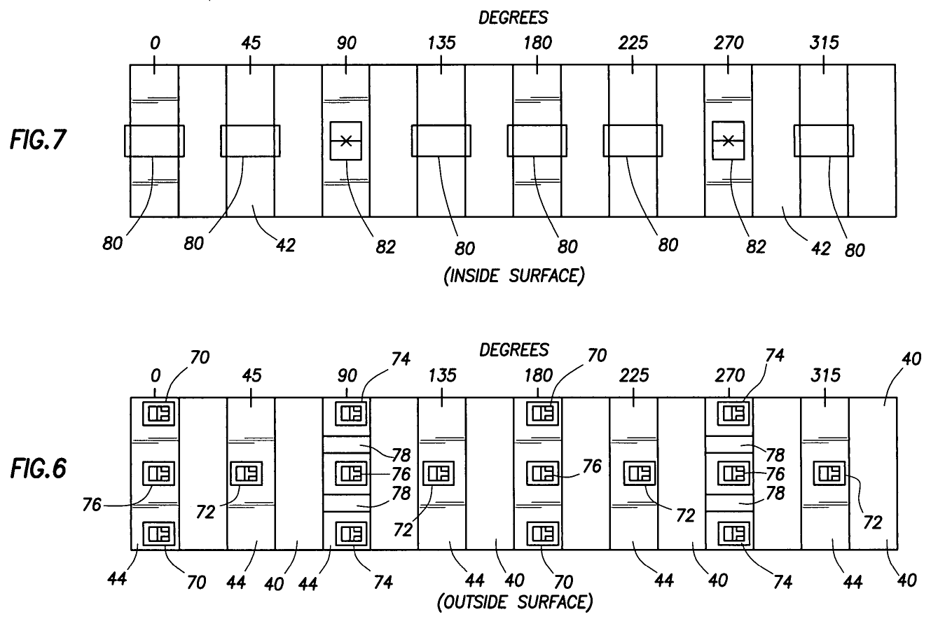

Individual bridges are mounted on the flats as illustrated in FIG. 6. Two additional bridges 82 are mounted on the inner surface 42 along with terminal strips 80, as illustrated in detail in FIG. 7. It would be preferable to mount the bridge elements 82 on flat on the inner surface 42. Such flats, however, might cause sufficient stress concentration to upset isolation of undesired components. Only interior corners cause significant stress concentration, and this is the reason that flats on the inside surface 42 are not used to alleviate congestion on the external flats.

FIG. 6 illustrates in detail the layout and function of individual bridge elements on the flattened outer surface 40 of the sensing element 16 shown in FIGS. 4 and 5. Reference degrees (see FIG. 5) are shown at the left of the layout. The letters “T” indicate tension measuring bridge elements, and the letters “C” indicate compression measuring bridge elements for positive sense definition. Outputs from the bridge elements 76 are combined to define and to measure a linear displacement with tension sense being illustrated. Outputs from the bridge elements 70 are combined to define and to measure an angular rotation from bending of the structure out of the reference plane with an upward concavity. Outputs from the bridge elements 74 are combined to define and to measure an angular deflection of the structure within the ring's plane with a concavity to the bottom (see FIG. 5). Outputs from the bridge elements 78 are combined to define and to measure the angular twist displacement resulting from right hand torque (see FIG. 5). Outputs from the bridge elements 72 are combined to define and to measure linear shear deflection in the reference plane as previously defined.

FIG. 7 illustrates terminal strips 80 to which individual bridges are completed, along with the layout and function of individual bridge elements on the cylindrical inner surface 42 of the sensing element 16 shown in FIGS. 4 and 5. Outputs from the bridge elements 82 are combined to define and to measure upward or downward linear shear displacements to distort the ends of the ring of the sensing element 16 vertically with respect to the reference plane. Stated another way, the cantilever beams 12 and 14 remain in the same angular relationship with respect to each other, but are vertically displaced to different elevations. The terminal strips 80 are used to connect the strain gage bridges into the proper displacement component isolation, and furnish robust connection of leads for excitation and signal to and from the specific bridge for a given component.

One or more temperature sensors (not shown) may be used to measure temperature of the sensing element 16 and to correct responses of the sensing element for adverse effects of changing temperature. A single temperature measure will typically be adequate, with calibration over a temperature range where the structure 26, cantilever beams 12 and 14, and sensing element 16 are close to equilibrium with each other. If this equilibrium is not present, differential temperature measurements between beam cantilevers 12 and 14, the sensing element 16, and the structure 26 may be necessary. The 10% FSO (full scale output) per 100° F. system response is for that temperature change, with all elements in equilibrium with each other, and generally is negligible for short term tests with small temperature differentials. For long term tests, it is preferred to match thermal expansion properties or the cantilever beams 12 and 14 and the sensing element 16 to the expansion properties of the structure 26 to reduce error.

The extensometer 10 is designed so that output from each sensor component is reasonably consistent with the low end of standard unamplified output for a metallic foil strain gage transducer.

Elements of the electronics package 24 of the extensometer system are illustrated in FIG. 8. The sensing element 16, comprising the previously discussed bridge elements, is powered by a power supply 94. Power is transmitted through one of a plurality of conductors, which has been previously identified by the numeral 32. The power supply 94 also provides power for other elements in the electronic package 24, and can comprise batteries, solar cells, land-line power, and the like. Signals from the extensometer 10 are input to the electronics package by the plurality of conductors 32 to a strain gage signal conditioner (SGSC) 92. Signals and other related measurements such as temperature can also be input into a processor 100. Previously discussed optional temperature corrections are preferably made in the processor 100. Eight channels of data are adequate for each of the individual six degrees of freedom, the optional inside temperature of the sensing element 16, and verification of the system excitation voltage. The SGSC 92 is operationally connected to a display 98 upon which up to six components of displacement (proportional to load) acting on the structure 26 can be displayed. Auxiliary measurements may also be displayed on the display unit.

Still referring to FIG. 8, a clock 96 is optionally connected to the display 98 through the processor 100. The clock 96 controls the scan rate of the extensometer system and allows complex load parameters of interest to be measured and displayed as a function of time, preferably at predetermined time intervals. Setting the resolution of the analog to digital converter to about 12 to 16 bits allows a system scan rate of about 15 samples per second from a 22 bits ADC. These parameters yield real-time dynamic monitoring of structures such as bridges, towers, buildings, airplanes, ship hulls, power lines and the like. Sampling rate is inverse with respect to resolution but reasonably proportional to frequency response.

It should be understood that not all elements shown in the electronics package 24 are required to operate the extensometer 10.

Calibration of the extensometer 10 is accomplished by applying discrete load components to a “standard” extensometer system. Additional extensometer systems are then calibrated with respect to the standard system so that second order effects such as cross talk can be observed and eliminated.

To summarize, the mirrored cantilever extensometer combined with the electronics package 24 allows real time diagnosis of complex loads on structures in dynamic as well as static conditions. The sensitivity of the system is scalable, through mechanical and component element design, for any practical range of service strain including post-yield conditions. The extensometer 10 can be reused, although certain new components must be supplied and system calibration and refurbishing is recommended.

While the foregoing disclosure is directed toward the preferred embodiments of the invention, the scope of the invention is defined by the claims, which follow.

1. An extensometer for measuring a load on a structure, the extensometer comprising:
(a) first and second cantilever beams, wherein each said beam has a fixed end and a free end; and
(b) a sensing element; wherein
(c) said free end of said first cantilever beam is affixed to a first side of said sensing element and said free end of said second cantilever beam is affixed to a second side of said sensing element, wherein said first and second sides are diametrically opposed;
(d) said fixed ends of each said cantilever beams are operationally attached to said structure; and
(e) said sensing element yields a response indicative of said load.

2. The extensometer of claim 1 wherein said sensing element response is magnified by a gage length that is greater than a sensing element length.

3. The extensometer of claim 1 wherein:
(a) said sensing element comprises a plurality of bridges;
(b) each said bridge comprises a plurality of arms; and
(c) said sensing element response is magnified by said plurality of arms.

4. The extensometer of claim 1 further comprising:
(a) a first vee block attached to said fixed end of said first cantilever beam; and
(b) a second vee block attached to said fixed end of said second cantilever beam; wherein
(c) said fixed end of said first said cantilever beam is operationally attached to said structure by affixing said first vee block to said structure to said structure; and
(d) said fixed end of said second said cantilever beam is operationally attached to said structure by affixing said second vee block to said structure.

5. The extensometer of claim 4 wherein:
(a) said first vee block is removably attached to said fixed end of said first cantilever beam; and
(b) said second vee block is removably attached to said fixed end of said second cantilever beam.

6. The extensometer of claim 1 wherein said sensing element responds to six degrees of freedom.

7. The extensometer of claim 1 further comprising a carrier bar that is removably attached to said first and said second cantilever beams thereby holding said extensometer in a restrained and essentially unstrainted position prior to and during affixing said extensometer to said structure.

8. An extensometer system for measuring a load on a structure, the extensometer system comprising:
(a) an extensometer comprising
(i) first and second cantilever beams wherein each said beam has a fixed end and a free end, and
(ii) a sensing element, wherein
(iii) said free end of said first cantilever beam is affixed to a first side of said sensing element and said free end of said second cantilever beam is affixed to a second side of said sensing element wherein said first and second sides are diametrically opposed,
(iv) said fixed ends of each said cantilever beams are operationally attached to said structure, and
(v) said sensing element yields a sensing element response indicative of said load; and
(b) an electronics package operationally connected to said sensing element, wherein said electronics package comprises
(i) a power supply to provide power to said sensing element,
(ii) a strain gage signal conditioner, and
(iii) a display.

9. The system of claim 8 wherein said sensing element response is magnified by a gage length that is greater than a sensing element length.

10. The system of claim 8 wherein:
(a) said sensing element comprises a plurality of bridges;
(b) each said bridge comprises a plurality of arms; and
(c) said sensing element response is magnified by said plurality of arms.

11. The system of claim 8 further comprising:
(a) a first vee block attached to said fixed end of said first cantilever beam; and
(b) a second vee block attached to said fixed end of said second cantilever beam; wherein
(c) said fixed end of said first said cantilever beam is operationally attached to said structure by affixing said first vee block to said structure; and
(d) said fixed end of said second said cantilever beam is operationally attached to said structure by affixing said second vee block to said structure.

12. The system of claim 11 wherein:
(a) said first vee block is removably attached to said fixed end of said first cantilever beam; and
(b) said second vee block is removably attached to said fixed end of said second cantilever beam.

13. The system of claim 8 wherein said sensing element responds to six degrees of freedom.

14. The system of claim 8 further comprising a carrier bar that is removably attached to said first and said second cantilever beams thereby holding said extensometer in a restrained, and essentially unstrained position prior to and during affixing said extensometer to said structure.

15. The system of claim 10 wherein said electronics package further comprises:
(a) a processor for converting said sensing element displacement response into said measure proportional to load; and
(b) a clock cooperating with said processor to obtain in real time said measure of load as a function of time.

16. The system of claim 15 comprising at least one temperature sensor, wherein response of said temperature sensor is combined with said sensing element response to correct said measure of load for temperature variation.

17. A method for measuring a load on a structure, the method comprising the steps of:
(a) providing an extensometer comprising
(i) first and second cantilever beams wherein each said beam has a fixed end and a free end; and
(ii) a sensing element;
(b) affixing said free end of said first cantilever beam to a first side of said sensing element and affixing said free end of said second cantilever beam to a second side of said sensing element wherein said first and second sides are diametrically opposed;
(c) operationally attaching said fixed ends of each said cantilever beam to said structure; and
(d) determining said load from a response of said sensing element to displacement.

18. The method of claim 17 wherein said sensing element response is magnified by a gage length that is greater than a sensing element length.

19. The method of claim 17 wherein:
(a) said sensing element comprises a plurality of bridges;
(b) each said bridge comprises a plurality of arms; and
(c) said sensing element response is magnified by said plurality of arms.

20. The method of claim 17 further comprising the additional steps of:
(a) attaching a first vee block to said fixed end of said first cantilever beam; and
(b) attaching a second vee block to said fixed end of said second cantilever beam; wherein
(c) operationally attaching said fixed end of said first said cantilever beam to said structure by affixing said first vee block to said structure; and
(d) operationally attaching said fixed end of said second said cantilever beam to said structure by affixing said second vee block to said structure.

21. The method of claim 20 comprising the additional steps of:
(a) removably attaching said first vee block to said fixed end of said first cantilever beam; and
(b) removably attaching said second vee block to said fixed end of said second cantilever beam.

22. The method of claim 17 wherein said sensing element responds to six degrees of freedom.

23. The method of claim 17 further comprising the steps of:
(a) providing a carrier bar; and
(b) removably attaching said carrier bar to said first and said second cantilever beams thereby holding said extensometer in a restrained and essentially unstrained position prior to and during affixing said extensometer to said structure.

24. An method for measuring complex loading on a structure, the method comprising:
(a) providing an extensometer comprising
(i) first and second cantilever beams wherein each said beam has a fixed end and a free end, and
(ii) a sensing element;
(b) affixing said free end of said first cantilever beam to a first side of said sensing element and affixing said free end of said second cantilever beam to a second side of said sensing element wherein said first and second sides are diametrically opposed;
(c) operationally attaching said fixed ends of each said cantilever beam to said structure;
(d) providing an electronics package;
(e) operationally connecting said electronics package to said sensing element, wherein said electronics package comprises
(i) a power supply to provide power to said sensing element,
(ii) a strain gage signal conditioner, and
(iii) a display for displaying a measure of said complex loading; and
(f) determining said measure of said complex loading from a sensing element response.

25. The method of claim 24 wherein said sensing element response is magnified by a gage length that is greater than a sensing element length.

26. The method of claim 24 wherein:
(a) said sensing element comprises a plurality of bridges;
(b) each said bridge comprises a plurality of arms; and
(c) said sensing element response to said load is magnified by said plurality of arms.

27. The method of claim 24 further comprising the steps of:
(a) attaching a first vee block to said fixed end of said first cantilever beam; and
(b) attaching a second vee block to said fixed end of said second cantilever beam; wherein
(c) operationally attaching said fixed end of said first said cantilever beam to said structure by affixing said first vee block to said structure; and
(d) operationally attaching said fixed end of said second said cantilever beam to said structure by affixing said second vee block to said structure.

28. The method of claim 27 comprising the additional steps of:
(a) removably attaching said first vee block to said fixed end of said first cantilever beam; and
(b) removably attaching said second vee block to said fixed end of said second cantilever beam.

29. The method of claim 24 wherein said sensing element responds to six degrees of freedom.

30. The method of claim 24 further comprising the additional steps of:
(a) providing a carrier bar; and
(b) removably attaching said carrier bar to said first and said second cantilever beams thereby holding said extensometer in a restrained position prior to and during affixing said extensometer to said structure.

31. The method of claim 24 comprises the additional steps of:
(a) providing a processor within said electronics package;
(b) within said processor, converting said response of said sensing element into said measure of said complex loading; and
(c) within said electronics package, providing a clock cooperating with said processor to obtain in real time said measure of said complex loading as a function of time.

32. The method of claim 31 comprising the additional steps of:
(a) providing at least one temperature sensor in said sensing element; and
(b) within said processor, combining a response of said at least one temperature sensor with said sensing element response to correct said measure of said complex loading for temperature variation.
